(19) United States
(12) Patent Application Publication
(10) Pub. No.: US 2016/0218461 A1
(43) Pub. Date: Jul. 28, 2016

(54) SUBSEA CONNECTION SYSTEM

(71) Applicant: SIEMENS AKTIENGESELLSCHAFT, München (DE)

(72) Inventor: Marcel PETIE, Radal (NO)

(21) Appl. No.: 14/916,202

(22) PCT Filed: Aug. 22, 2014
(86) PCT No.: PCT/EP2014/067932

§ 371 Date: Mar. 3, 2016

(30) Foreign Application Priority Data
Sep. 6, 2013 (EP) 13183370.9

(51) Int. Cl. H01R 13/62; H01R 43/26; H01R 13/631

(52) U.S. Cl. CPC H01R 13/6205; H01R 13/631; H01R 43/26

(57) ABSTRACT

A subsea connection assembly is provided. The subsea connection assembly includes first parts of at least two wet-mateable connectors. Each first part is wet-mateable with a complementary second part of the respective wet-mateable connector. The subsea connection assembly further includes a magnetic engagement member and a mounting structure. A method of engaging the subsea connection assembly is also disclosed.

### PRIORITY STATEMENT

This application is the national phase under 35 U.S.C. §371 of PCT International Application No. PCT/EP2014/067932 which has an International filing date of Aug. 22, 2014, which designated the United States of America and which claims priority to European patent application number EP13183370.9 filed Sep. 6, 2013, the entire contents of which are hereby incorporated herein by reference.

### FIELD

An embodiment of the present invention generally relates to a subsea connection assembly, to a subsea connection system and/or to a method of engaging a movable subsea connection assembly with a fixed subsea connection assembly.

### BACKGROUND

In different fields of application, electrical equipment needs to be installed under water, for example in shallow water or close to the ocean floor. Such applications comprise the production of hydrocarbons from a subsea well or the generation of electric power at an offshore location, for example by way of an offshore wind turbine, a tidal turbine or the like. Subsea installations which support the production of hydrocarbons from a subsea well generally consume electric power, which may for example be provided by way of an umbilical or a subsea cable. The electrical power may be used for operating a pump, a compressor or the like. On the other hand, offshore power generation facilities generally need an electrical connection for transporting the generated electric power to an onshore location. This may again occur via a subsea cable.

Such applications may benefit from the possibility of providing an electrical connection subsea, e.g. by using wet-mateable connectors. At present, most of the actions required for mating such connectors subsea are being performed by ROVs (remotely operated vehicles). An ROV is a self-propelled vehicle that is suitable for subsea use, it comprises a cable connection to a vessel or platform through which it receives control and power. A wet-mateable connector can comprise a receptacle part and a plug part which need to be mated in order to establish an electrical, an optical, or a hydraulic connection.

In order to mate the two connector parts, a mating force generally needs to be applied. The mating force is required to overcome the resistance of the internal mechanical mechanisms that are provided inside the wet-mateable connector. Similarly, when de-mating a wet-mateable connector, a force must be applied to overcome the internal mechanical resistance in order to pull the connector parts apart. The mating or de-mating force of such wet-mateable connector can be applied by the ROV.

The mating of larger connectors or multiple connectors may require higher forces. The force can be applied by the ROV directly, or by for example using a “screw” to slowly force the connector parts together. An electrical actuator may be used for turning the screw that brings the connector parts together. When large forces are required, a hydraulic force may also be used.

In some applications, the use of wet-mateable connectors may be problematic since ROVs have limited operating capabilities with regards to ambient water speed (e.g. currents when working on a tidal turbine) and mating forces that they can apply. Furthermore, for some applications, it is not desirable to include any hydraulic systems on the subsea installations or other devices, for example for tidal or wave energy devices. Also, it is undesirable to include electrical storage systems in such devices which are used to drive an actuator for mating or de-mating the connectors. Such systems would be cost intensive and would furthermore increase the complexity of the connection system.

Accordingly, it is desirable to facilitate the mating of connectors subsea. In particular, it is desirable to enable an efficient mating of several connectors, and to keep the complexity of connection systems low. Also, it is desirable to be able to mate the connectors without the use of an ROV.

### SUMMARY

Accordingly, the inventors have recognized that there is a need to improve the mating of connectors subsea, and in particular to provide a subsea connection assembly that obviates at least some of the drawbacks mentioned above.

The claims describe embodiments of the invention.

According to an embodiment of the invention, there is provided a subsea connection assembly comprising a first part of at least one wet-mateable connector, wherein the first part is wet-mateable with a complementary second part of the wet-mateable connector. The subsea connection assembly further comprises a magnetic engagement member adapted and arranged so as to supply a magnetic force to at least promote the engagement of the first connector part with the second connector part during mating.

According to a further embodiment of the invention, a subsea connection system is provided. The subsea connection system comprises a subsea connection assembly according to any of the above outlined embodiments. The subsea connection assembly is a movable subsea connection assembly. The subsea connection system further comprises a fixed subsea connection assembly. The fixed subsea connection assembly comprises the second part of the at least one wet-mateable connector and further comprises a complementary magnetic engagement member adapted and arranged to interact with the magnetic engagement member of the movable subsea connection assembly so as to generate the magnetic force. The movable subsea connection assembly is movable into engagement with the fixed subsea connection assembly so as to provide a connection between the first part and the second part of the wet-mateable connector. Accordingly, such subsea connection system may have a relatively low complexity, and is furthermore capable of providing a mating and de-mating of the movable and fixed subsea connection assemblies without the need to use an ROV or an hydraulic mating mechanism.

According to a further embodiment of the present invention, a method of engaging a movable subsea connection assembly comprising a first part of a wet-mateable connector with a fixed subsea connection assembly comprising a complementary second part of a wet-mateable connector is provided. The method comprises the steps of bringing the movable subsea connection assembly into a mating position in which the movable subsea connection assembly faces the fixed subsea connection assembly, applying, via an magnetic engagement member provided on the movable subsea connection assembly, a magnetic force by interaction with a complementary magnetic engagement member provided on the fixed subsea connection assembly, and bringing the movable subsea connection assembly into engagement with the fixed subsea connection assembly by the application of the magnetic force.

It is to be understood that the features mentioned above and those yet to be explained below can not only be used in the respective combinations indicated, but also in other combinations or in isolation without leaving the scope of the present invention. In particular, embodiments of the above outlined method may be performed by making use of a subsea connection assembly or a subsea connection system in any of the above described configurations. Similarly, the above described subsea connection assembly and subsea connection system may have any of the configurations described with respect to embodiments of the method.

### BRIEF DESCRIPTION OF THE DRAWINGS

The foregoing and other features and advantages of the invention will become further apparent from the following detailed description read in conjunction with the accompanying drawings. In the drawings, like reference numerals refer to like elements.

FIG. 1 is a schematic drawing showing a subsea connection assembly and a subsea connection system in accordance with an embodiment of the invention.

FIG. 2 is a schematic drawing showing a subsea connection assembly and a subsea connection system in accordance with an embodiment of the invention.

FIG. 3 is a flow diagram illustrating a method of mating a movable subsea connection assembly with a fixed subsea connection assembly in accordance with an embodiment of the invention.

### DETAILED DESCRIPTION OF EXAMPLE EMBODIMENTS

According to an embodiment of the invention, there is provided a subsea connection assembly comprising a first part of at least one wet-mateable connector, wherein the first part is wet-mateable with a complementary second part of the wet-mateable connector. The subsea connection assembly further comprises a magnetic engagement member adapted and arranged so as to supply a magnetic force to at least promote the engagement of the first connector part with the second connector part during mating.

The subsea connection assembly may comprise a mounting structure to which the first part of the at least one wet-mateable connector and the magnetic engagement member are mounted. The mounting structure may for example be affixed to the end of a power cable, in particular subsea cable for transporting supplied or generated electric power. In other embodiments, the mounting structure may be fixed to a subsea installation.

By way of the magnetic force provided by the magnetic engagement member, the mating of the first and second parts of the wet-mateable connector may thus be supported or may even be effected. Consequently, no ROV may be required to mate the first and second parts of the wet-mateable connector. Furthermore, there is no need for a hydraulic mating mechanism or the like. Thus, the complexity of the subsea connection assembly can be kept relatively low. When mating the first and the second parts of the wet-mateable connector, the magnetic force is an attractive magnetic force which pulls the first and second parts of the wet-mateable connector towards each other. The subsea connection assembly may also be configured to apply a repulsive magnetic force which supports or effects the disengagement of the first and second parts of the wet-mateable connector. Mating and de-mating of the connector parts may thus be facilitated.

Preferably, the subsea connection assembly comprises the first parts of at least two wet-mateable connectors (i.e. the first part of a first connector and the first part of a second connector). The at least two connectors are separate from each other, and each first part is configured to engage a complementary second part of the respective wet-mateable connector.

In an embodiment, the subsea connection assembly may for example comprise at least two plugs, or at least two receptacles, or any combination thereof (i.e. receptacle(s) and plug(s)). The wet-mateable connectors may be electrical, optical, or mixed wet-mateable connectors. They may be configured to transfer power and/or control/data signals. As an example, a plug part of a wet-mateable electric power connector, a plug part of a wet mateable electric data connector, and a plug part of an optical data connector may be provided in the subsea connection assembly, they may for example be mounted to a stab plate. Note that this is only an example, and that the types of wet-mateable connectors used in the subsea connection assembly depends on the particular application, for example on the type and amount of electric power that is to be transferred, on the required transfer of data and control signals and the like.

In an embodiment, the magnetic engagement member may be adapted and arranged so as to apply a magnetic force which effects the engagement of the first connector part with the second connector part during mating. In particular, the magnetic engagement member may be adapted and arranged so as to bring the subsea connection assembly from a mating position in which the first and second parts of the wet-mateable connector are not engaged into a mated position in which the first and second parts of the wet-mateable connector are in engagement, via the application of the magnetic force.

In an embodiment, the magnetic engagement member comprises at least one solenoid. By such solenoid, the application of a magnetic force may be controlled. The use of a solenoid may furthermore enable the switching of the application of an attractive magnetic force and a repulsive magnetic force.

An electrical connection from the at least one solenoid towards a power source may be provided. In particular, an electrical connection to a power source located on a floating vessel or on a fixed or floating offshore platform may be provided. In some embodiments, the electrical connection may be adapted to supply electric power to the solenoid, thus enabling the switching of the solenoid by way of the provision of electric power. In other embodiments, the electrical connection may comprise a connection for providing a control signal for sending control commands to a solenoid control unit comprised in the subsea connection assembly. Note that in some embodiments, plural solenoids can be provided, and the electrical connection may comprise only one power connection for driving all of these plural solenoids.

In an embodiment, a solenoid control unit may furthermore be provided, which is adapted to control the application of DC electric power to the solenoid, and it may furthermore control the polarity of the applied electric power so as to control the direction of the magnetic force. The solenoid control unit may be provided on board a floating vessel, on a floating or fixed offshore platform, or at an onshore site.

In an embodiment, the magnetic engagement member may comprise at least one permanent magnet. In such configuration, the subsea connection assembly may be mateable with a complementary subsea connection assembly which then comprises solenoids for controlling the mating and de-mating. In other embodiments, the subsea connection assembly may comprise both solenoids and permanent magnets. The number and configuration of solenoids and/or permanent magnets can be chosen such that the magnetic force is effectively applied so as to at least support or even effect the mating and de-mating of the first and second parts of the at least one mateable connector.

In an embodiment, the mounting structure comprises a stab plate. The first part of the wet-mateable connector can be mounted to the stab plate. When plural wet-mateable connectors are provided, the first part of each of these wet-mateable connectors can be mounted to the stab plate. Furthermore, since the magnetic engagement member is also mounted to the stab plate, it can be used to bring the first part(s) of the wet-mateable connector(s) into engagement with the respective second part(s), which can be mounted to a complementary support structure.

In an embodiment, the mounting structure may comprise a guiding element adapted to guide the engagement of the first connector part with the second connector part during mating. This may for example be a guiding pin mounted to the stab plate, or a guiding funnel or receptacle mounted to the stab plate for receiving such guiding pin. Accordingly, the application of magnetic force can be guided so that the first and the second parts of the wet-mateable connector move into engagement along a predefined path. In particular, the guiding element may be adapted to restrict the motion of the first connector part in lateral direction with respect to the second connector part, i.e. may restrict the motion in directions perpendicular to the mating direction during the mating process. As an example, the guide pin, when moving in the guide funnel, may only allow a movement parallel to the mating direction.

In an embodiment, the subsea connection assembly comprises at least two magnetic engagement members, preferably at least three or, more preferably, at least four magnetic engagement members. By way of at least four magnetic engagement members, a magnetic force that is high enough to effect the movement of the subsea connection assembly from a mating position into a mated position may be achieved, and furthermore, the magnetic force may be applied symmetrically, so that the motion in a direction parallel to the mating direction of the first and second connector parts is supported.

In an embodiment, the subsea connection assembly may be a cable termination head (CTH).

According to a further embodiment of the invention, a subsea connection system is provided. The subsea connection system comprises a subsea connection assembly according to any of the above outlined embodiments. The subsea connection assembly is a movable subsea connection assembly. The subsea connection system further comprises a fixed subsea connection assembly. The fixed subsea connection assembly comprises the second part of the at least one wet-mateable connector and further comprises a complementary magnetic engagement member adapted and arranged to interact with the magnetic engagement member of the movable subsea connection assembly so as to generate the magnetic force. The movable subsea connection assembly is movable into engagement with the fixed subsea connection assembly so as to provide a connection between the first part and the second part of the wet-mateable connector. Accordingly, such subsea connection system may have a relatively low complexity, and is furthermore capable of providing a mating and de-mating of the movable and fixed subsea connection assemblies without the need to use an ROV or an hydraulic mating mechanism.

In an embodiment, the magnetic engagement member of the movable subsea connection assembly comprises at least two solenoids, preferably at least four solenoids. The complementary magnetic engagement member of the fixed subsea connection assembly may comprise at least two permanent magnets, preferably at least four permanent magnets, arranged so as to interact with the at least two or four solenoids during engagement. The application of a relatively high and symmetric magnetic force during mating and de-mating may thus be achieved.

In an embodiment, the fixed subsea connection assembly comprises a mounting structure to which the second connector part (i.e. the second part of the wet-mateable connector) and the complementary engagement member are mounted. The mounting structure may for example be a stab plate. Accordingly, the movable and the fixed subsea connection assembly may each comprise a stab plate to which the respective part(s) of the wet-mateable connector(s) and the magnetic engagement member are mounted. In such configuration, several wet-mateable connectors can be mated simultaneously in an efficient and secure manner.

In an embodiment, the magnetic engagement member of the movable subsea connection assembly and the complementary magnetic engagement member of the fixed subsea connection assembly are configured such that they are capable of applying a magnetic force which moves the moveable subsea connection assembly from a mating position, in which the first and second parts of the wet-mateable connector are unmated, into a mated position, in which the first and second parts of the wet-mateable connector are mated. Accordingly, the magnetic engagement member and the complementary magnetic engagement member may be configured such that the magnetic force applied by them in the mating position is higher than the mating resistance of the one or more wet-mateable connectors forming part of the subsea connection system. The applied magnetic force can thus overcome the mating resistance so that the first and second parts of the wet-mateable connector(s) can be brought into engagement by the magnetic engagement member.

In particular, the magnetic force applied by the magnetic engagement member may be adjusted by adjusting the number of solenoids/permanent magnets provided on the fixed and movable subsea connection assemblies, by the magnetic field strength generated by the respective solenoids/permanent magnets and the like. Accordingly, if the subsea connection system comprises more wet-mateable connectors, the number of solenoids and permanent magnets may be increased, or the size of the solenoids and permanent magnets may be increased, or the electric power from driving the solenoid may be increased or any combination thereof.

In an embodiment, the subsea connection system further comprises a guiding structure adapted to guide the movable subsea connection assembly into a mating position in which the movable subsea connection assembly can be engaged with the fixed subsea connection assembly by the application of the magnetic force. In the mating position, the movable subsea connection assembly may for example face the fixed subsea connection assembly and upon providing electric power to the solenoids of the respective magnetic engagement member, the two subsea connection assemblies move into engagement. The guiding structure may for example guide the movable subsea connection assembly when it is lowered from a ship, e.g. via a winch cable attached to a hook on which the movable subsea connection assembly is suspended. The guiding structure may for example comprise a guide funnel or a metal frame, which will direct the movable subsea connection assembly into the mating position when it is lowered down from a floating vessel or offshore platform.

In an embodiment, the fixed subsea connection assembly may be mounted to a subsea structure of an offshore power generating device, such as an offshore wind turbine, an offshore tidal turbine, or a wave energy converter. Note that such subsea structure may be installed in some embodiments on the ocean floor, while in other embodiments, it may be suspended underwater.

According to a further embodiment of the present invention, a method of engaging a movable subsea connection assembly comprising a first part of a wet-mateable connector with a fixed subsea connection assembly comprising a complementary second part of a wet-mateable connector is provided. The method comprises the steps of bringing the movable subsea connection assembly into a mating position in which the movable subsea connection assembly faces the fixed subsea connection assembly, applying, via an magnetic engagement member provided on the movable subsea connection assembly, a magnetic force by interaction with a complementary magnetic engagement member provided on the fixed subsea connection assembly, and bringing the movable subsea connection assembly into engagement with the fixed subsea connection assembly by the application of the magnetic force.

By using such method for mating the movable and fixed subsea connection assemblies, advantages similar to the ones outlined further above with respect to the subsea connection assembly and the subsea connection system may be achieved. In particular, a controlled mating of the movable and fixed subsea connection assemblies becomes possible without the need to use an ROV and without requiring complex mating mechanisms, such as hydraulic mechanisms.

In an embodiment, the engagement member provided on the movable subsea connection assembly comprises a solenoid, and the complementary magnetic engagement member provided on the fixed subsea connection assembly comprises at least one permanent magnet. The permanent magnet has a pole with a predefined polarity, and the pole is facing the moveable subsea connection assembly in the mating position. The step of applying a magnetic force may comprise providing electric power to the solenoid such that the solenoid generates a pole of opposite plurality facing the pole of the permanent magnet. In such configuration, an attractive magnetic force is generated between the permanent magnet and the solenoid, so that the attractive magnetic force brings the movable and fixed subsea connection assemblies into engagement. Note that plural solenoids and permanent magnets having corresponding poles can be provided.

The method may further comprise the step of at least partially switching off the magnetic force by switching off the supply of electric power to the solenoid. In the mated position, the magnetic force may no longer be necessary to hold the first and second parts of the wet-mateable connector together, due to the mechanical resistance for de-mating. Accordingly, electric power can be saved by switching off the supply to the solenoid in the mated position.

The method may furthermore comprise the step of de-mating the movable subsea connection assembly from the fixed subsea connection assembly by applying a repulsive magnetic force via the magnetic engagement member and the complementary magnetic engagement member. The repulsive magnetic force may for example be applied by supplying DC electric power of reversed plurality to the solenoid of the fixed or movable subsea connection assembly. The magnetic engagement member is configured to generate repulsive magnetic force that is high enough to overcome the de-mating resistance of the wet-mateable connector(s), so that the movable subsea connection assembly can be brought from the mated position into the demated position via the application of the repulsive magnetic force.

In an embodiment, the step of bringing the movable subsea connection assembly into a mating position may involve lowering the movable subsea connection assembly from a vessel by a crane. As outlined above, a guiding structure may be provided for bringing the movable subsea connection assembly into the mating position when it is being lowered down from the floating vessel by a crane.

It is to be understood that the features mentioned above and those yet to be explained below can not only be used in the respective combinations indicated, but also in other combinations or in isolation without leaving the scope of the present invention. In particular, embodiments of the above outlined method may be performed by making use of a subsea connection assembly or a subsea connection system in any of the above described configurations. Similarly, the above described subsea connection assembly and subsea connection system may have any of the configurations described with respect to embodiments of the method.

In the following, embodiments of the invention will be described in detail with reference to the accompanying drawings. It is to be understood that the following description of the embodiments is given only for the purpose of illustration and is not to be taken in a limiting sense. The drawings are to be regarded as being schematic representations only, and elements in the drawings are not necessarily to scale with each other. Rather, the representation of the various elements is chosen such that their function and general purpose become apparent to a person skilled in the art.

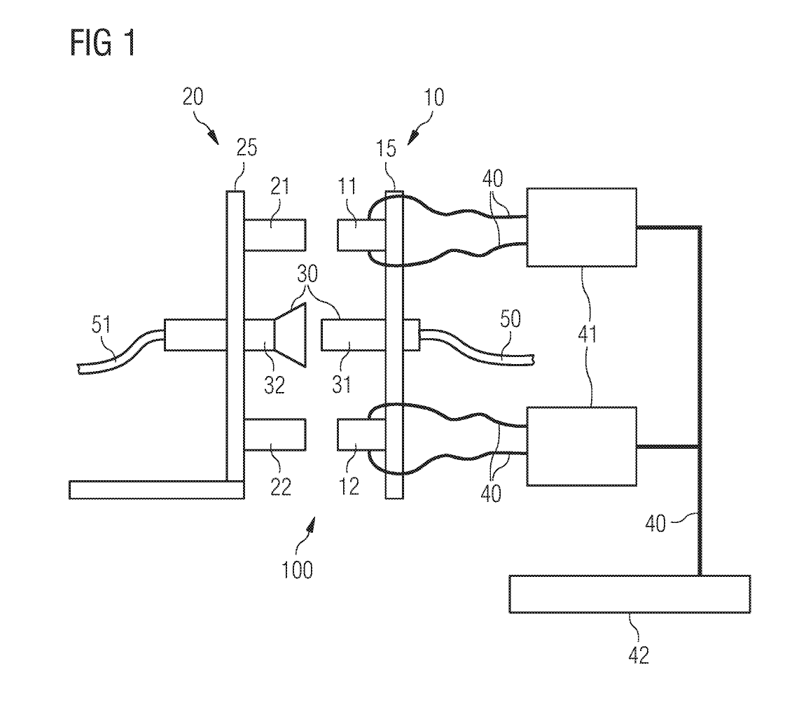

FIG. 1 schematically shows a subsea connection system 100 including a movable subsea connection assembly 10 and a fixed subsea connection assembly 20. The movable subsea connection assembly 10 may be mounted to the end of a subsea cable 50, it may for example be provided in form of a cable termination head (CTH). The fixed subsea connection assembly is mounted to a subsea structure of a power generating device, such as a subsea structure of an offshore wind turbine, a tidal turbine, a wave energy converting device or the like. Such subsea structure may also be a template used for power collection which is for example electrically connected to one or more of such devices, e.g. one or more wind turbines or tidal turbines.

In the embodiment of FIG. 1, the movable subsea connection assembly 10 comprises a stab plate 15 to which the first part 31 of a wet-mateable connector 30 is mounted. The first part 31, which may for example be a plug, is mateable with a second complementary part 32 of the wet mateable connector 30. In the example of FIG. 1, the second part 32 is a receptacle. The subsea connection system 100 may comprise plural of such wet-mateable connectors 30. These can be electrical connectors, optical connectors, mixed connectors, hydraulic connectors and the like. Accordingly, plural plugs 31 may be installed on stab plate 15, while plural receptacles 32 may be installed at the stab plate 25. It should be clear that this is only an example, and that in other embodiments, receptacles may be installed on stab plate 15, with mixed configurations (plugs and receptacles) being also conceivable.

Furthermore, a magnetic engagement member is provided which comprises the solenoids 11 and 12 mounted to stab plate 15. They are provided for interaction with permanent magnets and 22, respectively, mounted to stab plate 25 of the fixed subsea connection assembly 20. Further solenoids may be provided on stab plate 15, with further complementary permanent magnets being provided on stab plate 25. It should be clear that this is only one possibility of configuring the subsea connection system 100, and that in other embodiments, solenoids may be provided on the stab plate 25 of the fixed subsea connection assembly 20, and that more or fewer solenoids can be provided on the respective stab plate(s).

The fixed subsea connection assembly 20 comprises the stab plate 25 to which the permanent magnets 21 and 22 as well as the second part 32 of the wet-mateable connector 30 are mounted. As outlined above, the stab plate 25 is fixedly mounted to e.g. a subsea structure of an offshore wind turbine or tidal turbine, such as a base or tower structure, or a subsea template or the like. With the subsea connection system 100, one wet-mateable connector 30 or plural of such wet-mateable connectors can be brought into engagement simultaneously by moving the movable subsea connection assembly 10 from a mating position into a mated position in which the parts 31 and 32 of the wet-mateable connector are engaged. An electrical connection can thus be established from the subsea cable 50 to electric components of the subsea structure which are connected via electric connection 51 to the second part 32 of the wet-mateable connector 30.

In the embodiment of FIG. 1, the permanent magnets 21, 22 and the solenoids 11, 12 are configured such that they can generate an attractive magnetic force that overcomes the mating resistance of the one or more wet-mateable connectors 30, so that the movable subsea connection assembly 10 can be brought from the mating position into the mated position. For this purpose, electric connections 40 are provided to the solenoids 11, 12. By way of these electric connections 40, a DC voltage can be applied to the solenoids 11, 12, so that with the correct polarity, an attractive magnetic force will be generated. In particular, the polarity of the DC voltage is chosen such that the magnetic pole generated at the end of the solenoids 11 and 12 facing the fixed subsea connection assembly 20 have the opposite magnetic polarity than the ends of the permanent magnets 21, 22 which face the movable subsea connection assembly 10.

For the purpose of applying the DC voltage to the solenoids 11 and 12, solenoid control units 41 can be provided. These may receive power and control signals from a floating vessel 42, which may also be a floating offshore platform or a fixed offshore platform. The solenoid control units 41 are in FIG. 1 only illustrated as functional units. They may be implemented within the movable subsea connection assembly 10, for example within a cable termination head, or on board the floating vessel of offshore platform.

Although this is one possibility of providing electric power to the solenoids 11 and 12, other possibilities with reduced complexity are conceivable. As an example, all solenoids 11, 12 may be supplied with electric power via only a single electric connection 40, with the respective control unit being located on board the floating vessel 42. Thus, a single electric conductor from the floating vessel 42 to the solenoids 11, 12 may be sufficient for supplying a DC voltage to the solenoids, and the earth returned path can be provided via the subsea cable 50 or via the sea water. In other embodiments, two conductors may be provided for applying a DC voltage across the solenoids 11, 12.

By reversing the plurality of the DC voltage applied to solenoids 11, 12 the magnetic field generated by the solenoids 11, 12 can be reversed, thus generating a repulsive magnetic force. Accordingly, such magnetic force can be provided for de-mating the movable subsea connection assembly 10 from the fixed subsea connection assembly 20. The polarity of the applied DC voltage can for example be controlled by the solenoid control units 41, e.g. from the floating vessel 42, depending on the particular configuration.

In the example of FIG. 1, two permanent magnets 21, 22 and two solenoids 11, 12 are shown. Depending on the type of application, e.g. the number of wet-mateable connectors 30 mounted to stab plates 15 and 25, a different number of magnet/solenoid pairs may be used. In particular, the sizing and number of magnet/solenoid pairs can be adjusted so that the attractive magnetic force overcomes the mating resistance of the wet-mateable connectors 30, and that the repulsive magnetic force generated by these pairs overcomes the mechanical de-mating resistance of these wet-mateable connectors 30.

Solenoids 11, 12 may for example comprise a soft magnetic material around which a coil is wound. To the two end terminals of the coil, the DC voltage is applied to generate a magnetic field and thus a magnetic pole at the end of the solenoid. Providing the DC voltage from the floating vessel 42 has the advantage that no additional installations are required on the device towards which the fixed subsea connection assembly 20 is mounted. In other configurations, the use of solenoids on the fixed subsea connection assembly 20 is also possible. In even other embodiments, solenoids may be used on both, the movable subsea connection assembly 10 and the fixed subsea connection assembly 20. This has the advantage that the magnetic force can essentially be turned off completely (except some residual magnetization of e.g. the soft magnetic material).

The mechanical mating resistance of the wet-mateable connector 30 is generally known. Accordingly, by determining the magnetic force between the permanent magnets 21, 22 and the solenoids 11, 12, the required number and sizing of these magnets/solenoid pairs can be determined. Each solenoid is powered by a DC current, and the solenoid control units 41 are adapted to limit the current provided to the solenoids so that the soft magnetic material provided in the solenoids is not driven to high in their respective hysteresis loop and becomes saturated, which may lead to the material losing its magnetic capabilities. For approximating the magnetic force between permanent magnets and solenoids, a model with two bar magnets can be used as an approximation. For such configuration, the force between the two magnets is

$$F = [ \frac{{B}_{0}^{2} {A}^{2} ( {L}^{2} + {R}^{2} )}{π {μ}_{0} {L}^{2}} ] [ \frac{1}{{x}^{2}} + \frac{1}{{( x + 2 L )}^{2}} - \frac{2}{{( x + L )}^{2}} ] ,$$

wherein B₁ is the magnetic flux density close to each magnetic pole in unit of Tesla, A is the area of each pole in square meters, L is the length of each magnet in meters, R is the radius of each magnet in meters and x is the separation between the two magnets in meters. The flux density B₀ at the pole of the respective magnet can be determined from the magnetization M of the magnet:

$${B}_{0} = \frac{{μ}_{0}}{2} M$$

Accordingly, it is possible to adjust the number and sizing of the solenoids and the permanent magnets so as to generate a required magnetic force for mating and de-mating the movable subsea connection assembly 10 and the fix subsea connection assembly 20.

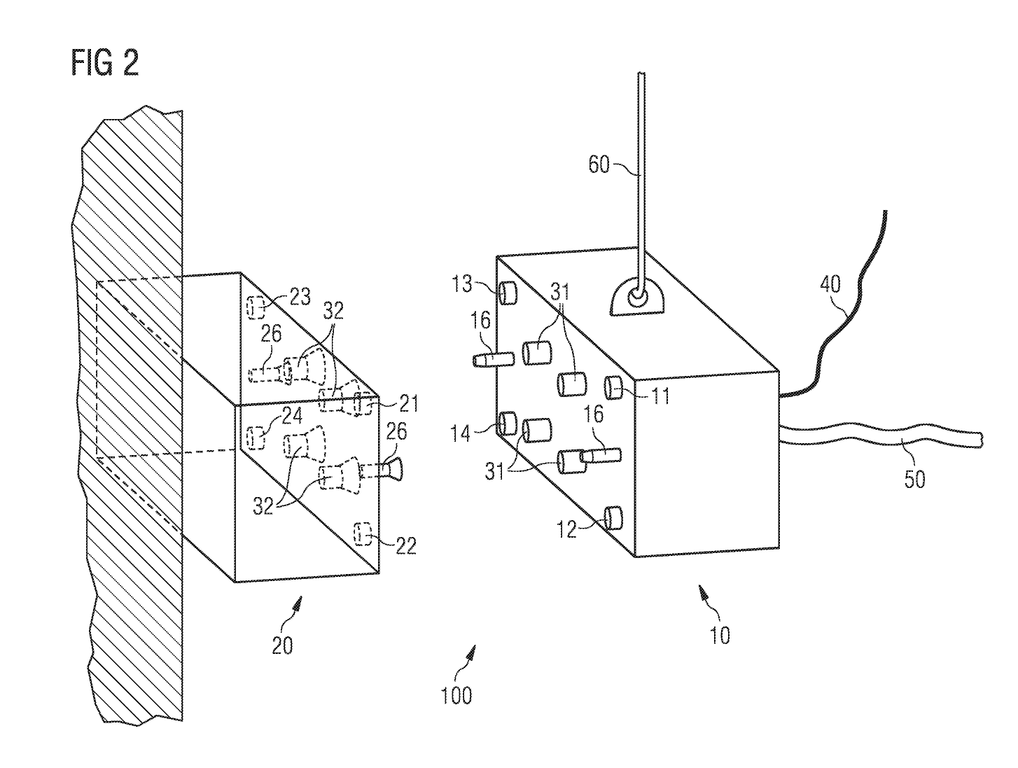

FIG. 2 shows a particular implementation of the subsea connection system 100 according to an embodiment of the invention. Accordingly, the explanations given above with respect to FIG. 1 are equally applicable to the subsea connection system 100 of FIG. 2. As can be seen, four wet-mateable connectors are provided in the subsea connection system 100, with the first parts 31, plugs in the present case, being mounted to a stab plate of the movable subsea connection assembly 10. The second parts 32, receptacles in the present example, are mounted to the fixed subsea connection assembly 20. Each of the plugs 31 may be connected to one or more conductors of the subsea cable 50. As an example, three of the wet-mateable connectors may be provided for enabling the transfer of three-phase AC electric power, each connector thus providing a connection for one phase. The fourth connector may for example be provided for providing data communication, e.g. for sending or receiving control commands, measuring data, and the like. The fourth connector may for example be an electrical connector or an optical connector. It may provide plural data connections simultaneously.

In the example of FIG. 2, four solenoids 11, 12, 13 and 14 are provided on the movable subsea connection assembly 10. The complementary magnetic engagement member of the fixed subsea connection assembly 20 comprises four complementary permanent magnets 21, 22, 23 and 24. Each solenoid 11, 12, 13 and 14 magnetically interacts with the respective permanent magnet 21, 22, 23 and 24. Accordingly, a magnetic force can be applied symmetrically, and by way of the four pairs of solenoids/permanent magnets, it is possible to apply a magnetic force that is high enough to overcome the mating resistances of the four wet-mateable connectors.

Furthermore, a guiding element is provided. This comprises on the movable subsea connection assembly 10 the guide pins 16. Furthermore, on the fixed subsea connection assembly 20, corresponding guide funnels 26 are provided. During engagement of the assemblies 10 and 20, the guide pin 16 moves into engagement with the guide funnel 26, thereby restricting any lateral motion of the movable subsea connection assembly 10. Lateral motion in this respect means any motion perpendicular to the mating direction. Accordingly, the interaction of the guide pin 16 with the guide funnel 26 only allows a motion in the mating direction of the connector parts 31, 32. Guide pins 16 and guide funnels 26 are only shown for the purpose of illustration and may have a rather different shape. Also, more guide elements may be provided, and they can be arranged differently. The guide elements allow the engagement of the first connector part 31 with the second connector part 32 to be guided during mating, so that these connector parts do not tilt or cant during engagement, which may lead to an increased mechanical mating resistance or even to damage to the connector parts.

In the embodiment of FIG. 2, an electric connection to a floating vessel 42 is provided. The electric connection 40 comprises two contactors via which a DC voltage can be applied across all solenoids 11, 12, 13 and 14. Individual control of the different solenoids may not be necessary, since it will generally be desirable to apply a symmetric magnetic force to allow a mating of the assemblies 10 and 20 without tilting.

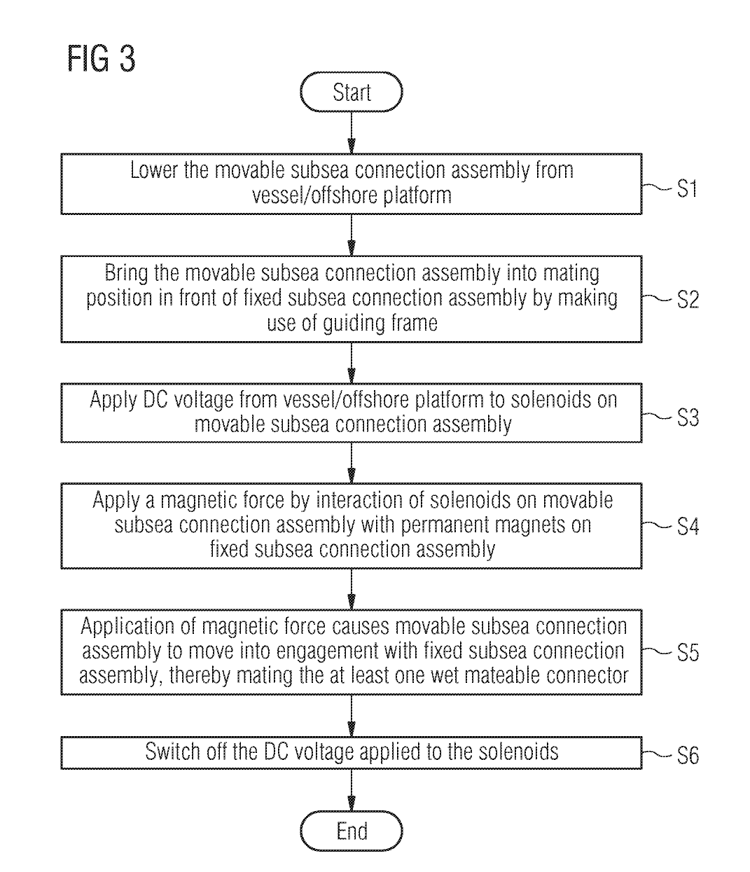

FIG. 3 shows a flow diagram of a method of engaging a movable subsea connection assembly with a fix subsea connection assembly. The method may for example be performed by way of the assemblies 10 as illustrated and described with respect to FIGS. 1 and 2. In a first step S1, the movable subsea connection assembly 10 is lowered from the floating vessel 42, or from an offshore platform, by for example using a wire rope 60 as illustrated in FIG. 2. The subsea installation to which the fixed subsea connection assembly 20 is mounted may comprise a guiding structure, for example a guiding frame (not shown), for guiding the movable subsea connection assembly 10 into a mating position in which it faces the fixed subsea connection assembly 20. Such mating position may for example correspond to the position as illustrated in FIG. 1. Note that in FIG. 2, the assemblies 10 and 20 are spaced further apart for the purpose of illustration.

By making use of such guiding frame when lowering the movable subsea connection assembly 10, it is brought into the mating position in front of the fix subsea connection assembly (step S2). As an example, the assembly 10 is lowered down into the sea by a crane of the vessel and will by its own weight sink down. The assembly 10 will reach the mating position by the guiding structure, e.g. the guide frame or guide funnels, which will guide the assembly into close proximity to the fixed assembly 20 and which will provide lateral alignment of the first and second connector parts 31, 32.

When the movable subsea connection assembly 10 is the mating position, the solenoids 11, 12, 13, 14 are energized and they will generate a magnetic field with a polarity opposite to the one of the permanent magnets 21 to 24. Energization is performed in step S3 by applying a DC voltage from the floating vessel or offshore platform to the solenoids 11 to 14 on a movable subsea connection assembly 10.

In step S4, the interaction of the energized solenoids on the movable subsea connection assembly 10 with the permanent magnets on the fixed subsea connection assembly 20 applies a magnetic force, which will move the movable subsea connection assembly 10 towards the fixed subsea connection assembly 20. As outlined above, the permanent magnets and solenoids are configured such that the magnetic force will overcome the mating resistance of the connector parts 31 and 32. Accordingly, the application of the magnetic force causes the movable subsea connection to move into engagement with the fixed subsea connection assembly 20, thereby mating the one or more wet-mateable connectors 30 (step S5). After the mating of the movable and fixed assemblies 10, 20, the supply of DC voltage to the solenoids 11 to 14 can be switched off (step S6). The permanent magnets 21 to 24 will still exert a magnetic force on the soft magnetic material of the solenoids. This magnetic force together with the de-mating resistance of the wet-mateable connectors 30 will keep the connectors in place once the solenoids are de-energized. In this mated position, the assembly 10 is thus securely connected to the assembly 20.

If a de-mating of the assemblies 10, 20 is furthermore required, then the method may comprise a further step in which a DC voltage with reversed polarity is applied to the solenoids. A magnetic field may thus be generated such that the solenoids and permanent magnets have poles of the same polarity facing each other. A repulsive magnetic force is thus generated which pushes the movable subsea connection assembly 10 away from the fix subsea connection assembly 20. The wet-mateable connectors 30 are thus de-mated. After de-mating, the DC power supplied to the solenoids can be switched off and the movable subsea connection assembly 10 can safely be retrieved to the surface, e.g. to the floating vessel or the offshore platform.

Although FIGS. 1 and 2 illustrate the mating of the movable and fixed assemblies 10, 20 in a horizontal direction, it should be clear that mating may also be performed in a vertical direction. The subsea connection system 100 may comprise a single or may comprise plural wet-mateable connectors 30. Since the electric power for energizing the solenoid is provided from a floating vessel or offshore platform, no power is required from the subsea template or structure, e.g. from the tidal turbine, wave energy device, or subsea power distribution network which may connect such units together. Furthermore, it should be clear that although embodiments were described with respect to the application in the field of offshore power generation, embodiments may as well be used in the field of offshore hydrocarbon production, e.g. at subsea installations at which a subsea power grid provides electric power to components such as pumps, compressors and the like.

As can be seen from the above, the subsea connection system 100 including the subsea connection assemblies 10 and has several advantages. Mating of the connection assemblies 10 and 20 can be achieved without requiring an ROV or any hydraulic mating mechanism. Furthermore, several wet-mateable connectors may be mated simultaneously. The mating mechanism employed in embodiments of the invention does not require any additional hydraulic or electrical connections at the fixed subsea installation. An electrical connection to a floating vessel deploying the movable subsea connection assembly 20 for energizing the solenoids is generally sufficient. The subsea connection system 100 has thus a relatively low complexity and it can be provided cost efficiently.

While specific embodiments are disclosed herein, various changes and modifications can be made without departing from the scope of the invention. The present embodiments are to be considered in all respects as illustrative and non-restrictive, and all changes coming within the meaning and equivalency range of the appended claims are intended to be embraced therein.

1. A subsea connection system, comprising:
a movable subsea connection assembly including
first parts of at least two separate wet-mateable connectors, each of the first parts being wet-mateable with a complementary respective second part of the at least two wet-mateable connectors, wherein each of the two wet-mateable connectors includes a mating resistance that needs to be overcome by application of a mating force during mating,
a magnetic engagement member, and
a mounting structure, to which the first parts of the at least two wet-mateable connectors and the magnetic engagement member are mounted;
a fixed subsea connection assembly including the second parts of the at least two wet-mateable connectors and a complementary magnetic engagement member adapted and arranged to interact with the magnetic engagement member of the movable subsea connection assembly; and
a guiding structure, configured to guide the movable subsea connection assembly into a mating position in which the movable subsea connection assembly is engagable with the fixed subsea connection assembly by the application of a magnetic force,
wherein the magnetic engagement member and the complementary magnetic engagement member are adapted and arranged so as to enable application of a magnetic force to bring the movable subsea connection assembly from the mating position, in which the first and second parts of the at least two wet-mateable connectors are not engaged, into a mated position, in which the first and second parts of the at least two wet-mateable connectors are in engagement, so as to provide a connection between the first part and the second part of each of the respective at least two wet-mateable connectors, and wherein the magnetic force is which will overcomes the mating resistance of the at least two separate wet-mateable connectors during mating.

2. The subsea connection system of claim 1, wherein the magnetic engagement member comprises at least one solenoid.

3. The subsea connection system of claim 2, further comprising:
an electrical connection, from the at least one solenoid towards a power source.

4. The subsea connection system of claim 1, wherein the magnetic engagement member comprises at least one permanent magnet.

5. The subsea connection system of claim 1, wherein the first parts of the at least two wet-mateable connectors comprise two plug parts, two receptacle parts or a plug part and a receptacle part.

6. The subsea connection system of claim 1, wherein the mounting structure comprises a stab plate.

7. The subsea connection system of claim 1, wherein the mounting structure comprises a guiding element, adapted to guide the engagement of the first part with the second part of the at least two wet-mateable connectors during mating.

8. The subsea connection system of claim 1, wherein the movable subsea connection assembly comprises at least two magnetic engagement members.

9. The subsea connection system of claim 1, wherein the magnetic engagement member of the movable subsea connection assembly comprises at least two solenoids, and wherein the complementary magnetic engagement member of the fixed subsea connection assembly comprises at least two permanent magnets arranged to interact with the at least two solenoids during engagement.

10. The subsea connection system of claim 1, wherein the fixed subsea connection assembly comprises a mounting structure, to which the second connector parts and the complementary magnetic engagement member are mounted.

11. A method of engaging a movable subsea connection assembly including first parts of at least two separate wet-mateable connectors with a fixed subsea connection assembly including complementary second parts of the wet-mateable connectors, each of the two wet-mateable connectors including a mating resistance that needs to be overcome by application of a mating force during mating, the method comprising:
bringing the movable subsea connection assembly into a mating position by way of a guiding structure, configured to guide the movable subsea connection assembly into the mating position in which the movable subsea connection assembly faces the fixed subsea connection assembly and in which the first and second parts of the at least two wet-mateable connectors are not engaged;
applying, via a magnetic engagement member provided on the movable subsea connection assembly, a magnetic force by interaction with a complementary magnetic engagement member provided on the fixed subsea connection assembly; and
bringing the movable subsea connection assembly into engagement with the fixed subsea connection assembly by the application of said magnetic force, wherein the magnetic force overcomes the mating resistance of the at least two separate wet-mateable connectors during mating, and wherein in the mated position, the first and second parts of the at least two wet-mateable connectors are in engagement so as to provide a connection between the first part and the second part of each of the respective at least two wet-mateable connectors.

12. The method of claim 11, wherein the engagement member provided on the movable subsea connection assembly comprises at least one solenoid and wherein the complementary magnetic engagement member provided on the fixed subsea connection assembly comprises at least one permanent magnet including a pole with a predefined magnetic polarity, the pole facing the movable subsea connection assembly in the mating position, and wherein the applying of a magnetic force comprises:
providing electric power to the solenoid such that the solenoid generates a pole of opposite magnetic polarity facing the pole of the permanent magnet.

13.-15. (canceled)

16. The subsea connection system of claim 1, wherein the guiding structure is a guide funnel or a guide frame.

17. The subsea connection system of claim 3, wherein the power source is a power source located on a floating vessel or an offshore platform.

18. The subsea connection system of claim 8, wherein the movable subsea connection assembly comprises at least 3 or 4 magnetic engagement members.

19. The subsea connection system of claim 10, wherein the mounting structure is a stab plate.

20. The method of claim 11, wherein the guiding structure is a guide funnel or a guide frame.
